(19) United States
(12) Patent Application Publication
(10) Pub. No.: US 2015/0221035 A1
(43) Pub. Date: Aug. 6, 2015

(54) RETIREMENT SAVINGS PLAN MYTHBUSTER

(71) Applicant: BANK OF AMERICA CORPORATION, Charlotte, NC (US)

(72) Inventors: Judith M. Anderson, East Walpole, MA (US); M. Katherine Lavelle, Roslindale, MA (US); Ronald Klear, Warrington, PA (US)

(73) Assignee: BANK OF AMERICA CORPORATION, Charlotte, NC (US)

(21) Appl. No.: 14/170,220

(22) Filed: Jan. 31, 2014

(51) Int. Cl. G06Q 40/06

(52) U.S. Cl. CPC G06Q 40/06

(57) ABSTRACT

A microsite for busting retirement savings plan myths, particularly for small businesses, is disclosed. A user may access the disclosed microsite via an Internet website. The microsite, hosted at an enhanced computing server, may display common small business retirement savings plan myths. Upon request, the microsite may provide facts busting each of the common myths. The microsite may also display a series of questions to aid the user in selecting an appropriate retirement savings plan type. Using permutation rules stored at the enhanced computing server, the microsite is able to analyze the user's answers to the series of questions and provide feedback in the form of a suggested retirement savings plan type. Thus, the microsite is able to quickly and efficiently educate the user and bust previously held myths about retirement savings plans for small business owners that may be standing in the way of their establishing one to save for their retirement.

### TECHNICAL FIELD

Aspects of the disclosure relate generally to a microsite for providing retirement savings plan information. Specifically, aspects of the disclosure relate to a system and method for receiving and analyzing pertinent data and using the pertinent data to provide retirement savings plan type options.

### BACKGROUND

Many small business owners know that they need to plan for retirement, however the significant majority have not done so. There is plan type/product confusion in the marketplace whereby small business owners do not know what retirement plan type would best fit their needs and the needs of their employees. This is usually interpreted as “hard work”. Many are not familiar with the industry terms and acronyms (e.g. SEP) and jargon (e.g. discrimination testing, fiduciary). Many small business owners feel that they do not have enough employees to make offering a retirement plan “worthwhile” or think it's too costly. Many small business owners also feel that they cannot afford the company match (401(k) or SIMPLE), lack stable cash flow, and that there is a lack of employee interest in retirement savings plans.

Thus, there is a need for a simple, engaging, interactive way to guide small business owners to the right retirement solution that breaks through the clutter and captures the small business owner's attention.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Certain aspects disclose a computer-implemented method, comprising: receiving, at an enhanced computing server, a request to view retirement savings plan information; displaying, at the enhanced computing server, the retirement savings plan information, wherein the retirement savings plan information provides myth-busting facts to common retirement savings plan myths; receiving, at the enhanced computing server, a request for a retirement savings plan type suggestion; displaying, at the enhanced computing server, a plurality of retirement savings plan questions, each answered in turn; receiving, at the enhanced computing server, answers to the plurality of retirement savings plan questions; analyzing, at the enhanced computing server, the answers to the plurality of retirement savings plan questions to generate a suggested retirement savings plan type, wherein the suggested retirement savings plan type is generated by applying a set of permutation rules to the answers to the plurality of retirement savings plan questions; and outputting, at the enhanced computing server, the suggested retirement savings plan type.

Certain other aspects disclose a non-transitory computer-readable storage medium having computer-executable program instructions stored thereon that, when executed by a processor, cause the processor to: receive a request to view retirement savings plan information; output the retirement savings plan information, wherein the retirement savings plan information provides myth-busting facts to common retirement savings plan myths; receive a request for a retirement savings plan type suggestion; output a plurality of retirement savings plan questions; receive answers to the plurality of retirement savings plan questions; analyze the answers to the plurality of retirement savings plan questions to generate a suggested retirement savings plan type, wherein the suggested retirement savings plan type is generated by applying a set of permutation rules to the answers to the plurality of retirement savings plan questions; and output the suggested retirement savings plan type.

Certain other aspects disclose an apparatus comprising: a memory; a processor, wherein the processor executes computer-executable program instructions which cause the processor to: receive a request to view retirement savings plan information; output the retirement savings plan information, wherein the retirement savings plan information provides myth-busting facts to common retirement savings plan myths; receive a request for a retirement savings plan type suggestion; output a plurality of retirement savings plan questions, each answered in turn; receive answers to the plurality of retirement savings plan questions; analyze the answers to the plurality of retirement savings plan questions to generate a suggested retirement savings plan type, wherein the suggested retirement savings plan type is generated by applying a set of permutation rules to the answers to the plurality of retirement savings plan questions; and output the suggested retirement savings plan type.

The details of these and other embodiments of the disclosure are set forth in the accompanying drawings and description below. Other features and advantages of aspects of the disclosure will be apparent from the description, drawings, and claims.

### BRIEF DESCRIPTION OF THE DRAWINGS

All descriptions are exemplary and explanatory only and are not intended to restrict the disclosure, as claimed. The accompanying drawings, which are incorporated in and constitute a part of this specification, illustrate embodiments of the disclosure and, together with the description, serve to explain principles of the disclosure. In the drawings:

FIG. 1 shows an illustrative operating environment in which various aspects of the disclosure may be implemented.

FIG. 2 shows an illustrative block diagram of network devices and server that may be used to implement the processes and function of one or more aspects of the present disclosure.

FIG. 3 shows an illustrative flow chart in accordance with aspects of the disclosure.

FIGS. 4-18 show illustrative screen shots of a retirement savings plan microsite according to aspects of the disclosure.

### DETAILED DESCRIPTION

In accordance with various aspects of the disclosure, methods, non-transitory computer-readable media, and apparatuses are disclosed for monitoring and outputting server inventory trends. In certain aspects, when a server receives a request data from a computing device, the server processes and analyzes the request and provides the requested data. The automated process may utilize various hardware components (e.g., processors, communication servers, memory devices, and the like) and related computer algorithms to generate image data related to the agency's business data.

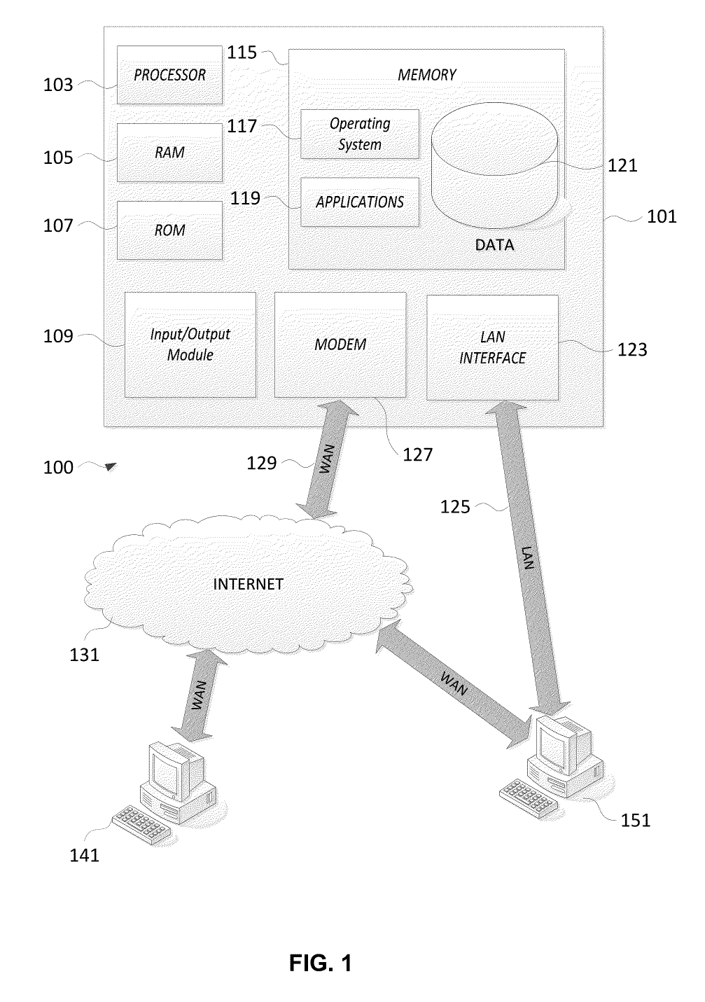

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

With reference to FIG. 1, the computing system environment 100 may include an enhanced computing server 101 wherein the processes discussed herein may be implemented. The enhanced computing server 101 may have a processor 103 for controlling the overall operation of the enhanced computing server 101 and its associated components, including random-access memory (RAM) 105, read-only memory (ROM) 107, communications module 109, and memory 115. Processor 103 and its associated components may allow the enhanced computing server 101 to run a series of computer-readable instructions related to receiving, storing, and analyzing data.

Enhanced computing server 101 typically includes a variety of computer-readable media. Computer-readable media may be any available media that may be accessed by enhanced computing server 101 and include both volatile and non-volatile media, removable and non-removable media. For example, computer-readable media may comprise a combination of computer storage media and communication media.

Computer storage media include volatile and non-volatile, removable and non-removable media implemented in any method or technology for storage of information such as computer-readable instructions, data structures, program modules, or other data. Computer storage media include, but are not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information that can be accessed by enhanced computing server 101.

Computing system environment 100 may also include optical scanners (not shown). Exemplary usages include scanning and converting paper documents, such as correspondence, data, and the like to digital files.

Although not shown, RAM 105 may include one or more applications representing the application data stored in RAM 105 while the enhanced computing server 101 is on and corresponding software applications (e.g., software tasks) are running on the enhanced computing server 101.

Communications module 109 may include a microphone, keypad, touch screen, and/or stylus through which a user of enhanced computing server 101 may provide input, and may also include one or more of a speaker for providing audio output and a video display device for providing textual, audiovisual and/or graphical output.

Software may be stored within memory 115 and/or storage to provide instructions to processor 103 for enabling enhanced computing server 101 to perform various functions. For example, memory 115 may store software used by the enhanced computing server 101, such as an operating system 117, application programs 119, and an associated database 121. In certain aspects, enhanced computing server 101 may comprise a plurality of databases 121. Also, some or all of the computer executable instructions for enhanced computing server 101 may be embodied in hardware or firmware.

Enhanced computing server 101 may operate in a networked environment supporting connections to one or more remote computing devices, such as computing devices 141 and 151. The computing devices 141 and 151 may be personal computing devices or servers that include many or all of the elements described above relative to the enhanced computing server 101.

The network connections depicted in FIG. 1 include a local area network (LAN) 125 and a wide area network (WAN) 129, but may also include other networks. When used in a LAN networking environment, enhanced computing server 101 may be connected to the LAN 125 through a network interface or adapter in the communications module 109. When used in a WAN networking environment, the enhanced computing server 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system may be operated in a client-server configuration to permit a user to retrieve web pages from a web-based server. Any of various conventional web browsers may be used to display and manipulate web pages.

Additionally, one or more application programs 119 used by the enhanced computing server 101, according to an illustrative embodiment, may include computer executable instructions for invoking functionality related to communication including, for example, email short message service (SMS), and voice input and speech recognition applications. In addition, the application programs 119 may include computer executable instructions for invoking user functionality related to access a centralized repository for performing various service tasks like routing, logging, and protocol bridging.

Embodiments of the disclosure may include forms of computer-readable media. Computer-readable media include any available media that can be accessed by an enhanced computing server 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For instance, aspects of the method steps disclosed herein may be executed on a processor 103 on enhanced computing server 101. Such a processor may execute computer-executable instructions stored on a computer-readable medium.

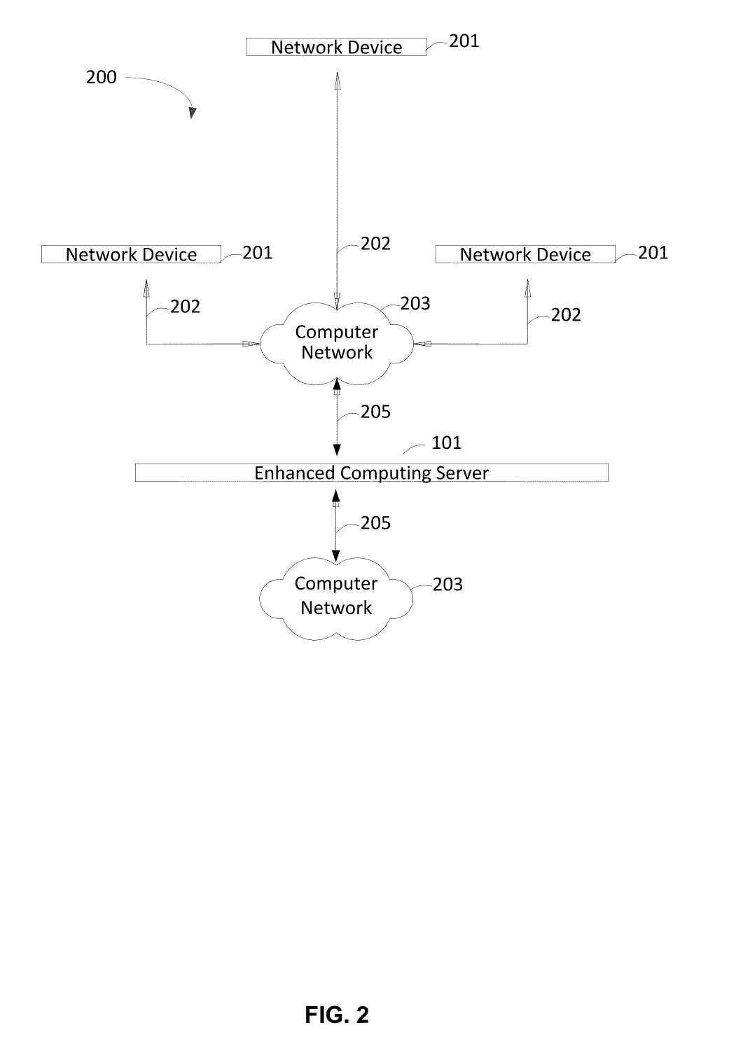

FIG. 2 illustrates another example operating environment in which various aspects of the disclosure may be implemented. As illustrated, system 200 may include one or more network devices 201. Network devices 201 may, in some examples, be connected by one or more communications links 202 to computer network 203 that may be linked via communications links 205 to server 204. In system 200, server 204 may be any suitable server, processor, computer, or data processing device, or combination of the same. Server 204 may be used to process the instructions received from, and the transactions entered into by, one or more participants.

According to one or more aspects, system 200 may be associated with a financial institution. Various elements may be located within the financial institution and/or may be located remotely from the financial institution. For instance, one or more network devices 201 may be located within a branch office of a financial institution. Such network devices may be used, for example, by customer service representatives, other employees, and/or customers of the financial institution in conducting financial transactions via network 203. Additionally or alternatively, one or more network devices 201 may be located at a user location (e.g., a customer's home or office). Such network devices also may be used, for example, by customers of the financial institution in conducting financial transactions via computer network 203.

Computer network 203 may be any suitable computer network including the Internet, an intranet, a wide-area network (WAN), a local-area network (LAN), a wireless network, a digital subscriber line (DSL) network, a frame relay network, and asynchronous transfer mode network, a virtual private network (VPN), or any combination of any of the same. Communications links 202 and 205 may be any communications links suitable for communicating between network devices 201 and server 204, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

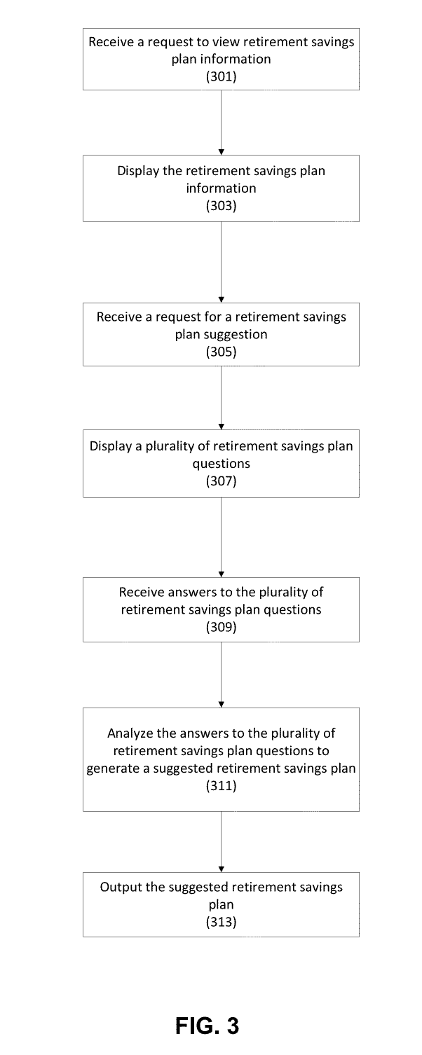

FIG. 3 illustrates a flowchart of an exemplary process according to aspects of the disclosure. The process may begin at step 301. In certain aspects, the process steps shown in FIG. 3 may be performed at a server, such as enhanced computing server 101. For instance, at step 301, enhanced computing server 101 may receive a request to view retirement savings plan information.

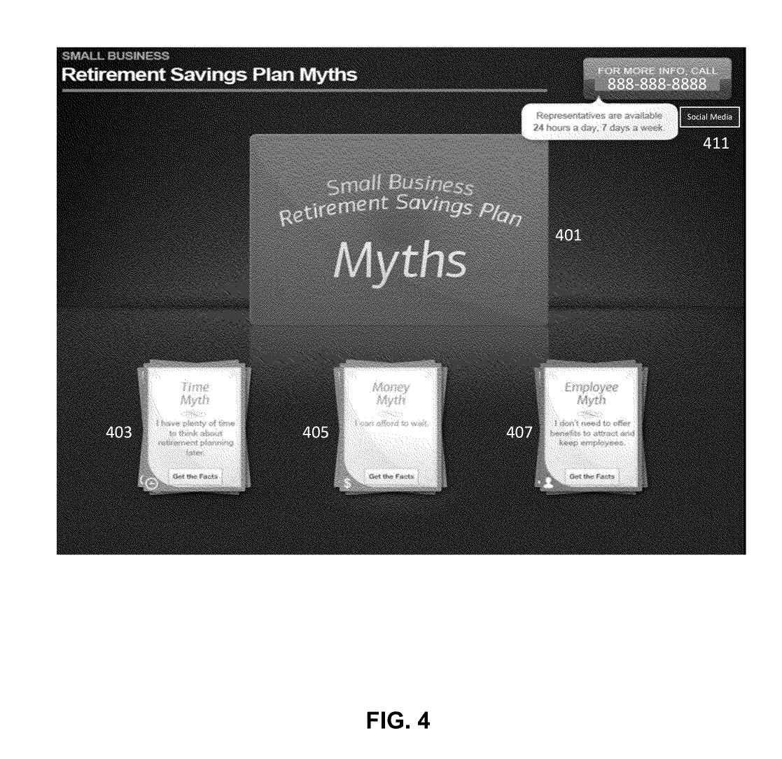

In certain aspects, enhanced computing server 101 may host data accessible by one or more users. For example, enhanced computing server 101 may post data to a website accessible via the Internet. The website may serve as a retirement savings plan microsite for the user. A user may access the retirement savings plan microsite using a network device 201. For example, a user may enter into network device 201 a universal resource locator (URL) to access a website associated with the enhanced computing server 101. The web site and enhanced computing server 101 may be managed by an enterprise such as a financial institution. After the user enters the appropriate URL (or selects an appropriate link, and the like), enhanced computing server 101 may display a website including the retirement savings plan microsite. An exemplary screen shot of the retirement savings plan microsite is shown in FIG. 4.

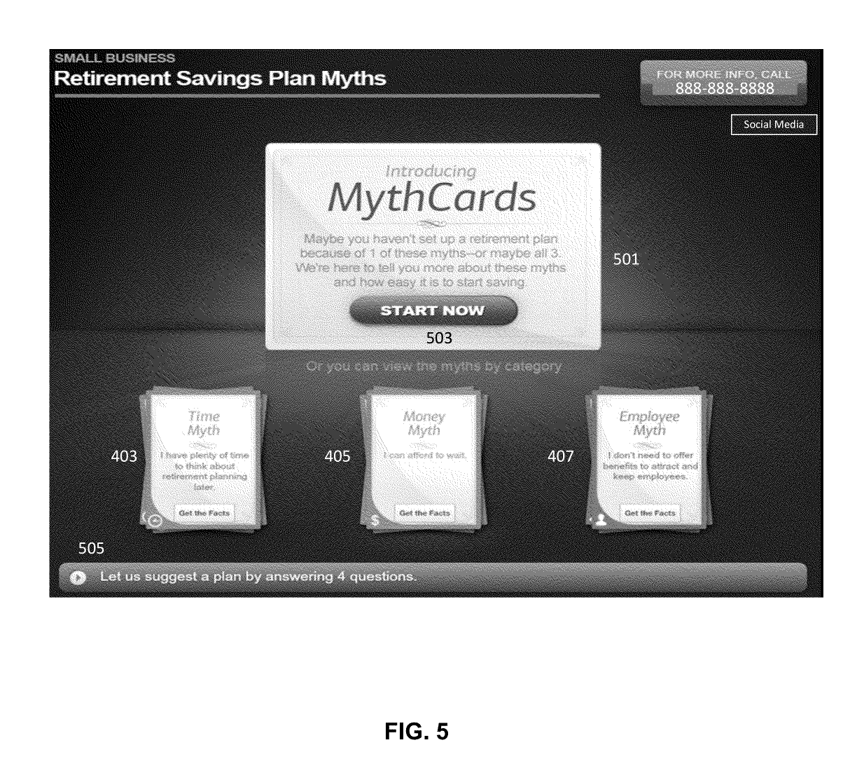

In the example shown in FIG. 4, the retirement savings plan microsite includes a home card 401, time myth theme 403, money myth theme 405, and employee myth theme 407 (collectively referred to herein as myth themes). Each of the myth themes may be presented as hyperlinks. Each hyperlink, when selected, may cause enhanced computing server 101 to display a subsequent web page. Moreover, each myth theme may be associated with three myth cards. For example, time myth theme 403 may be associated with three time myth cards. Similarly, money myth theme 405 and employee myth theme 407 may be associated with three money myth cards and three employee myth cards, respectively. Also shown in FIG. 4 is a phone number to call and social media link 411. Selecting social media link 411 may cause enhanced computing server 101 to connect to one or more popular social media websites. As should be understood, the retirement savings plan microsite may include other element not shown in FIG. 4. Similarly, the retirement savings plan microsite may, in some aspects, not comprise all of the elements shown in FIG. 4. In certain aspects, the illustrative screen shown in FIG. 4 may serve as a transitory, introductory screen that may automatically change to the illustrative screen shown in FIG. 5 after a few seconds. Thus, a user may only be able to view the screen shown in FIG. 4 for a few seconds and may not be shown again unless the user refreshes or exits and enters the microsite.

Referring back to FIG. 3, enhanced computing server 101 may receive a request to view retirement savings plan information at step 301. The request to view retirement savings plan information may comprise a selection of one or more myth categories/themes shown in FIG. 4 as time, money, and employee. For example, a user may select, via a computing device 141, select a myth theme, such as time myth theme 403. Enhanced computing server 101 may be automatically notified when the time myth theme 403 is selected and this notification may serve as the request to view retirement savings plan information. In this particular example, the retirement savings plan information may comprise information related to retirement savings plan time myths.

In certain aspects, a user may be presented with home card 401. After a period of time, such as a few seconds, home card 401 may be flipped so as to display revealed home card 501 shown in FIG. 5. The illustrative screen shot shown in FIG. 5 may serve as a home page for the retirement savings plan microsite. As shown in FIG. 5, revealed home card 501 may comprise an introduction and instructions for utilizing the retirement savings plan microsite. The introduction may be concise and free of industry jargon. Similarly, the other myth themes and descriptions provided by the retirement savings plan microsite may be free of, or use very limited technical terms. Where technical terms and industry jargon are used by the retirement savings plan microsite, the retirement savings plan microsite may provide definitions of the terms. Thus, the retirement savings plan microsite may be able to provide a simplified explanation of retirement savings plan consideration that may be easily understood by users with any or no level of retirement savings plan knowledge.

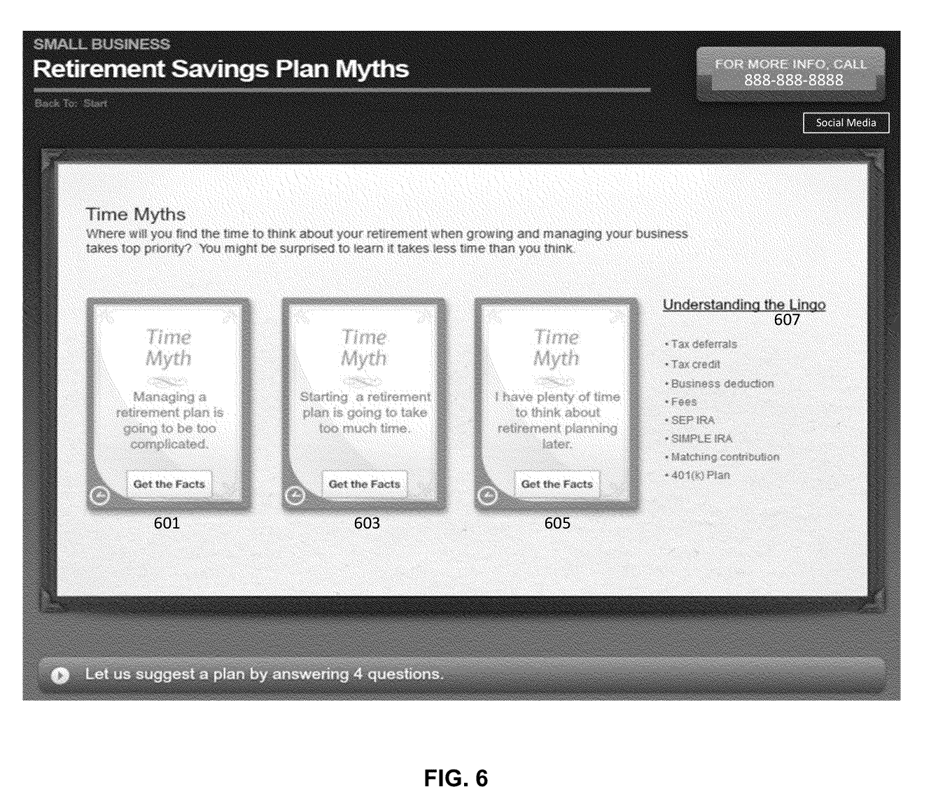

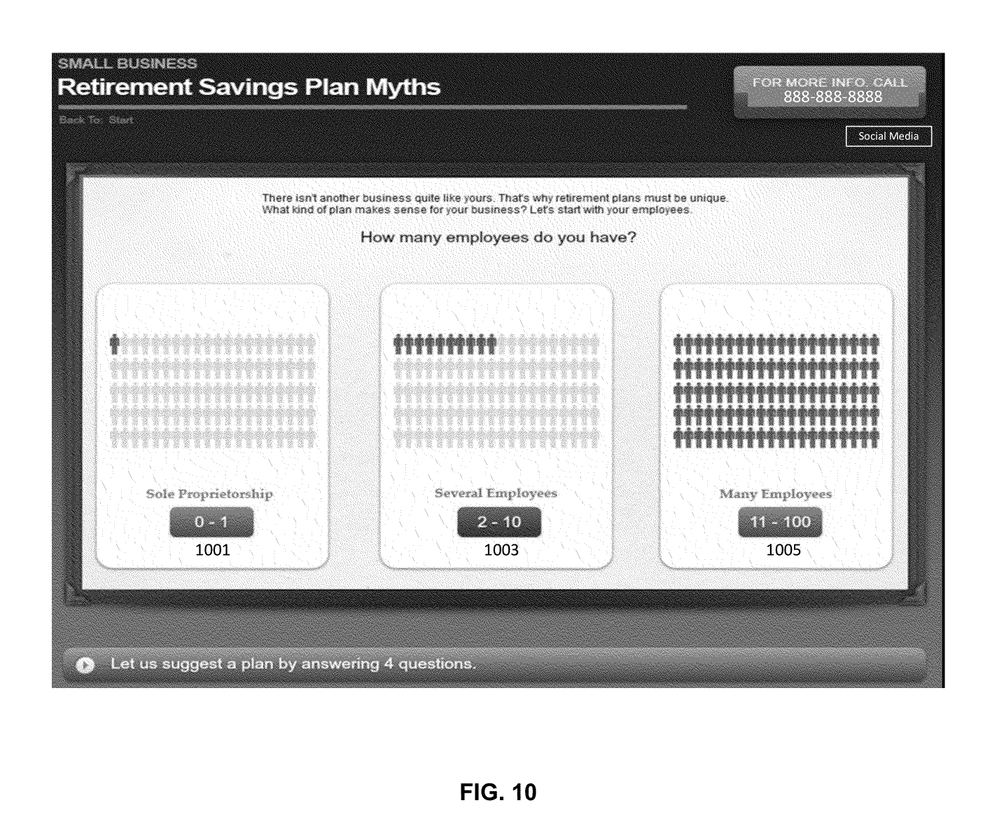

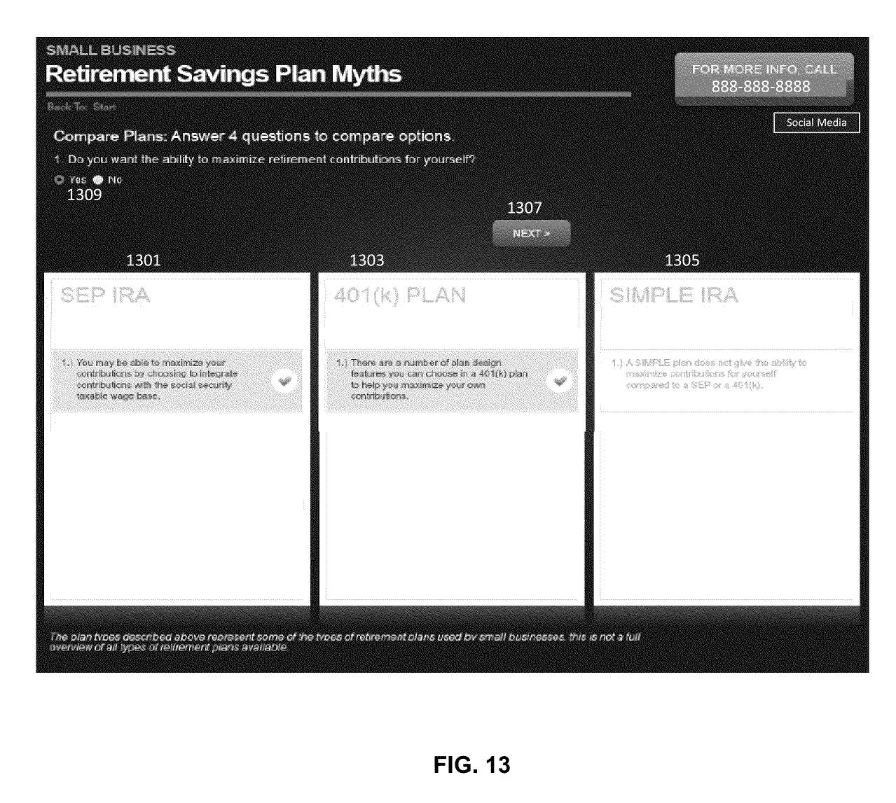

Revealed home card 501 may also comprise a process initiation link 503. In some aspects, when a user selects process initiation link 503, enhanced computing server 101 may be automatically notified. This notification may serve as a request to view retirement savings plan information at step 301. Thus, enhanced computing server 101 may receive a request to view retirement savings plan information at step 301 when a user selects at least one of process initiation link 503, time myth theme 403, money myth theme 405, and employee myth theme 407. As discussed below, when a user selects process initiation link 503, enhanced computing server 101 may display a screen similar to the illustrative screen shown in FIG. 10. Also shown in FIG. 5 are myth themes 403, 405, and 407 along with questionnaire link 505. Selection of any the links 503, 403, 405, 407, and 505 may enable a user to navigate through a different path of the retirement savings plan microsite. As discussed in greater detail below, selection of process initiation link 503 may enable a user to navigate by employer size via a screen shown in FIG. 10; selection of questionnaire link 505 may enable a user to navigate by answering questions as displayed in FIG. 13; and selection of any of myth themes 403, 405, and 407, such as time myth theme 403, may enable a user to navigate by theme via a screen as displayed in FIG. 6.

After enhanced computing server 101 receives a request to view retirement savings plan information at step 301, enhanced computing server 101 may display the retirement savings plan information at step 303. The retirement saving plan information may be stored at memory 115. An example of a screen that may display the retirement savings plan information is shown in FIG. 6. The screen shown in FIG. 6 may be displayed by enhanced computing server 101 after a user selects time myth theme 403.

As shown in FIG. 6, the retirement savings plan information may comprise common retirement savings plan myths. In particular, the retirement savings plan information may comprise information specifically tailored for small businesses. Each myth may comprise a misconception small business owner's hold with regards to retirement savings plans. The example provided in FIG. 6 displays three common time myths in associated myth cards that small business owners may hold with regards to retirement savings plans for their business. The time myths may comprise one or more of the following myths: “managing a retirement plan is going to be too complicated,” as shown in time myth card 601, “starting a retirement plan is going to take too much time,” as shown in time myth card 603, and “I have plenty of time to think about retirement planning later,” as shown in time myth card 605. Each of the plurality of myths may be stored in database 121. Each of the plurality of myths may preferably be provided in plain English, without industry jargon. The language provided in the myth cards may communicate to a user as if they are colleagues. Moreover, the language provided in the myth cards may preferably convey information in actionable bite sized chunks. For instance, each of the myths may not exceed one sentence in some aspects.

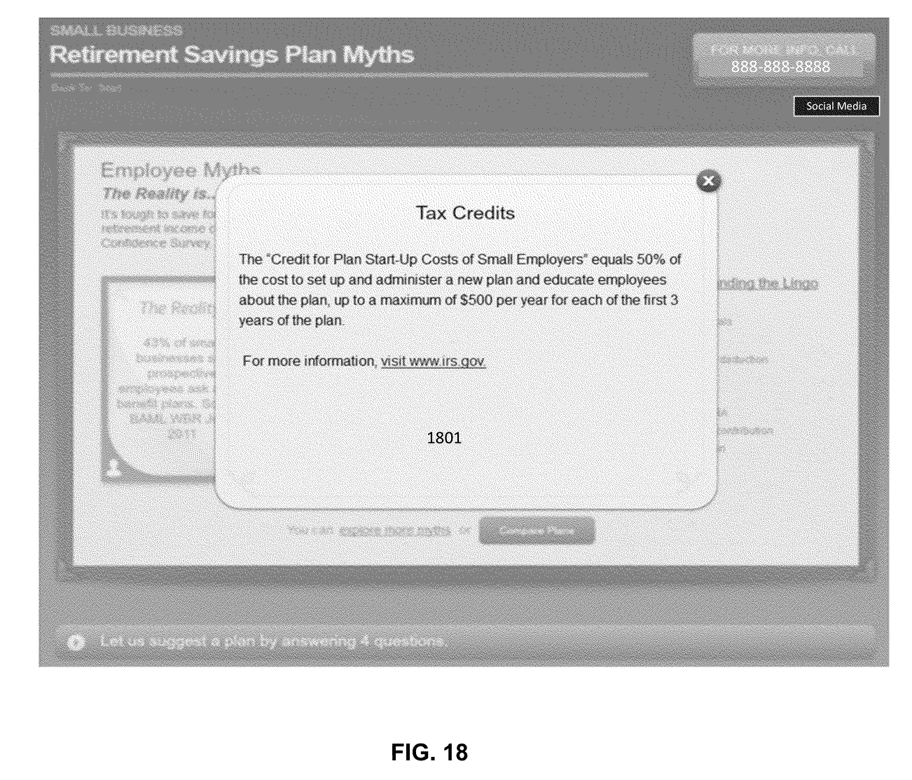

Also shown in FIG. 6, the retirement savings plan microsite may comprise a lingo section 607. Lingo section 607 may display one or more industry terms that may be relevant to small businesses. Each of the industry terms may be listed as hyperlinks. When a user selects one industry term hyperlinks, such as tax credits, the retirement savings plan microsite may display a screen similar to the screen shown in FIG. 18. Selecting an industry term may cause enhanced computing server 101 to display a pop up screen 1801 defining the selected industry term. The definition may comprise information defining the industry term. The definition may also comprise information explaining how they industry term may impact a small business's retirement savings plan. In certain aspects, no practitioner terminology, acronyms or concepts are introduced that are not defined in Lingo section 607.

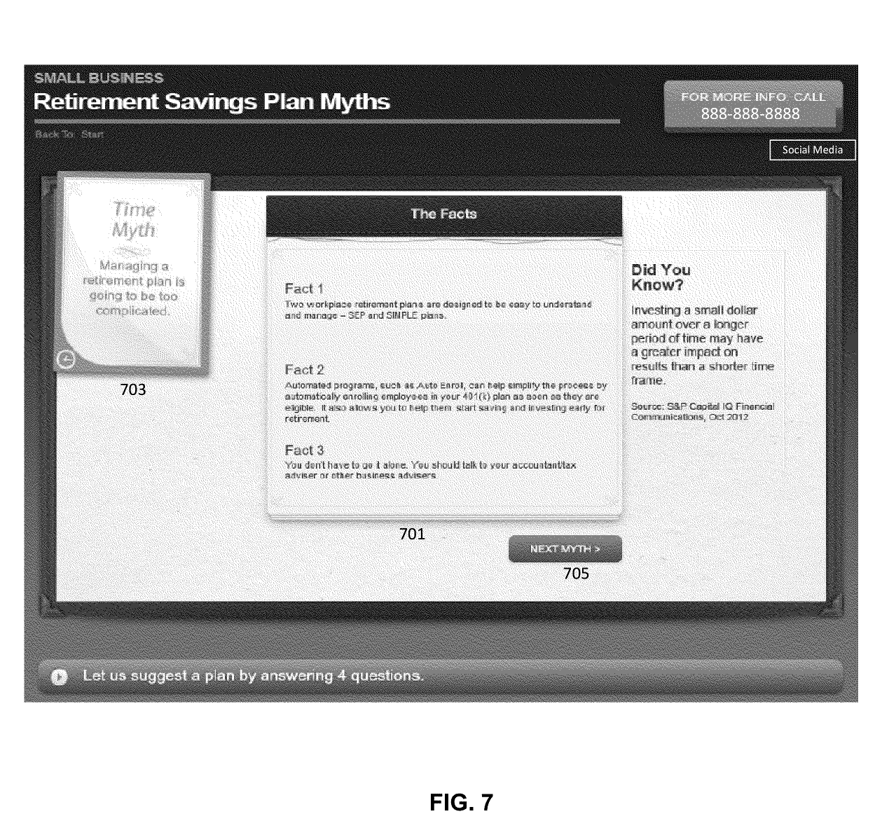

Each of the time myth cards 601, 603, and 605 may comprise a Get the Facts link. A user may select any of the Get the Facts links, such as the Get the Facts link in time myth card 601. In response, enhanced computing server may display a screen as shown in FIG. 7. The screen shown in FIG. 7 comprises a facts list 701. The facts list 701 may display one or more facts pertaining to the selected myth card and myth theme. For instance, facts list 701 lists three facts pertaining to time myth card 601. The selected time myth card (in this case time myth card 601) may be displayed at card display 703. Thus, enhanced computing server 101 may enable a user to quickly and easily acquire relevant facts about a particular myth. Moreover, the screen shown in FIG. 7 may include a Did You Know section which may provide additional details pertaining to the selected myth theme without use of technical terms and industry jargon. A single Did You Know section may be provided per theme. To advance to the next myth card for the selected myth theme (in this case myth theme 403), a user may select next myth link 705.

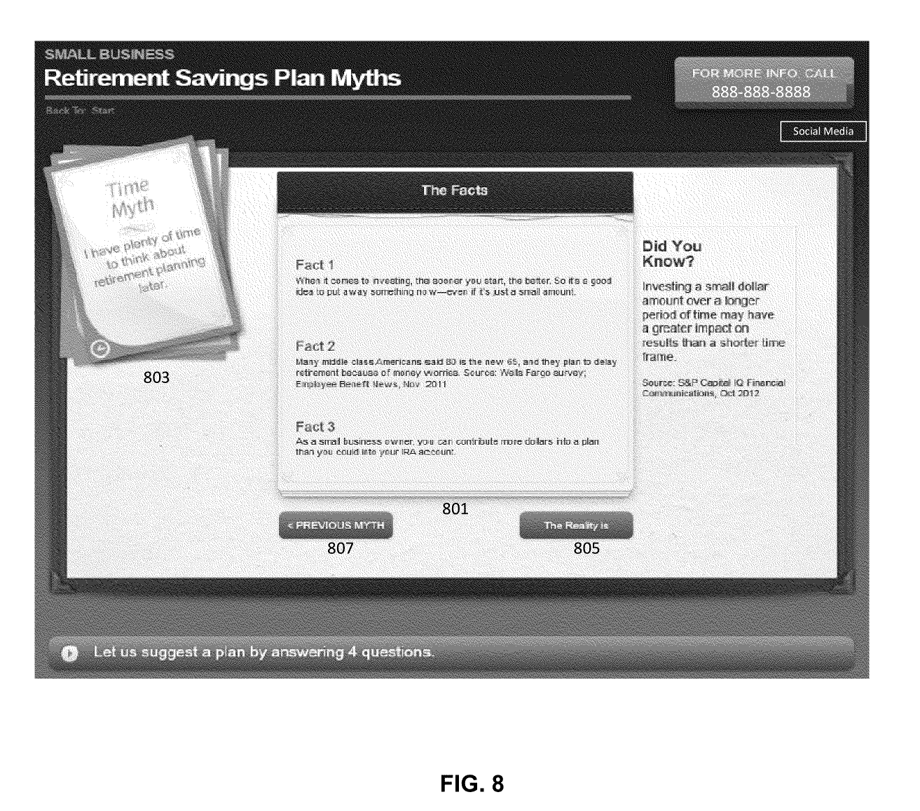

In response to selection of next myth link 705, enhanced computing server 101 may display a screen similar to the screen shown in FIG. 7, except the screen may pertain to the next myth card for the selected myth theme (in this case, time myth card 603). Enhanced computing server 101, may similarly display three facts in facts list 701 that pertain to time myth card 603 (which may be displayed at card display 703). Similarly, enhanced computing server 101 may display a Did You Know section for the time myth theme. A user may select next myth link 705 again to advance to the third and final myth card for the selected time myth theme (here, time myth theme 403). In response, enhanced computing server 101 may display a screen as shown in FIG. 8.

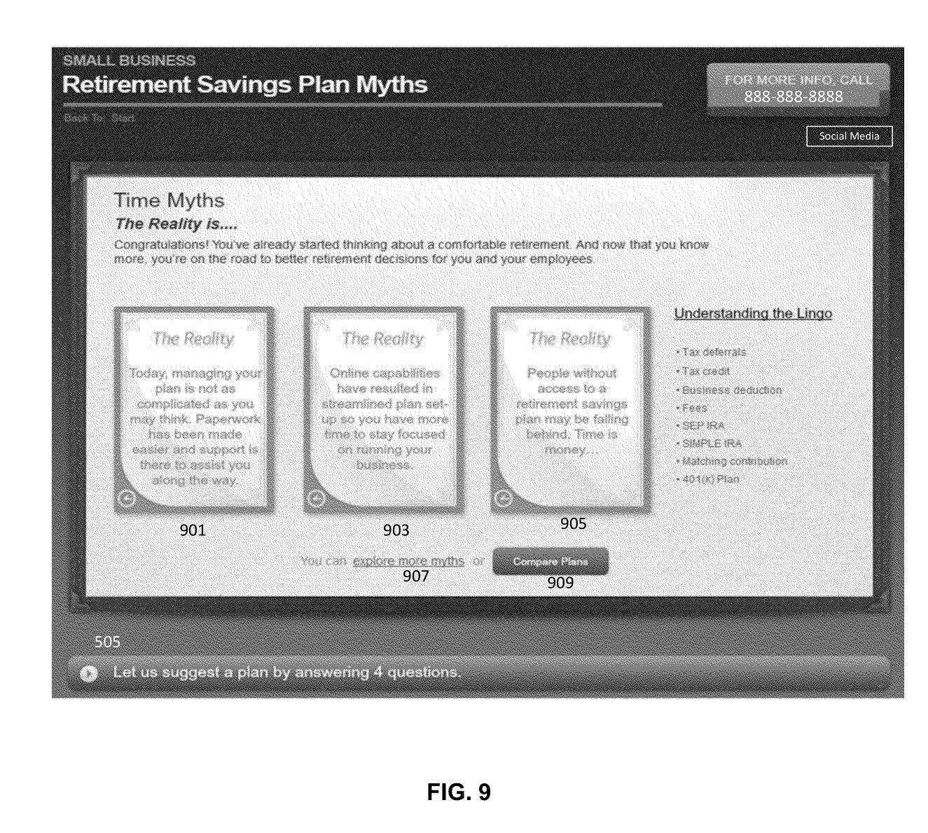

The screen shown in FIG. 8 is similar to the screen shown in FIG. 7. The screen shown in FIG. 8 comprises a facts list 801, which may be similar to facts list 701 except that facts list 801 provides three relevant facts about time myth card 605, shown at card display 803. FIG. 8 may also comprise a previous myth link 807 that, when selected, may cause enhanced computing server 101 to display a screen shown in FIG. 7 with pertinent information regarding a previously selected myth card (such as time myth cards 601 and 603). Enhanced computing server may also provide a reality link 805 that, when selected, causes enhanced computing server 101 to display a screen as shown in FIG. 9.

After proceeding through the three myth cards provided for a selected myth, enhanced computing server 101 may display a screen similar to the screen shown in FIG. 9 which may provide realities for each of the myth cards. As shown in FIG. 9, enhanced computing server may display reality cards 901, 903, and 905. The reality cards may serve as mythbusters, detailing facts that may counter its corresponding myth. For example, reality card 901 may state the following: “Today managing your plan is not as complicated as you may think. Paperwork has been made easier and support is there to assist you along the way.” Reality card 901, therefore, may counter its corresponding time myth card 601, which may state the following time myth: “Managing a retirement plan is going to be too complicated.” The retirement savings plan information displayed at step 303 may comprise the information displayed in the reality cards.

The retirement savings plan microsite may also comprise an exploration link 907. When exploration link 907 is selected, enhanced computing server 101 may display a screen similar to the screen shown in FIG. 5. In some aspects, enhanced computing server 101 may display similar the screen shown in FIG. 6. The exemplary screen shown in FIG. 6 and FIG. 9 pertains to time myths. Similar screens may be displayed for other myths, such as money myths and employee myths. For instance, after displaying screens shown in FIG. 6 and FIG. 9 pertaining to time myths, enhanced computing server 101 may receive a notification that a user has selected exploration link 907. Enhanced computing server 101 may, then, display a screen similar to the screen shown in FIG. 6 that pertains to money myths. The money myths may comprise three money myth cards that correspond to three money reality cards. Each of the myth cards pertaining to the plurality of myth may be displayed with short, simple language that may be easily understood by users.

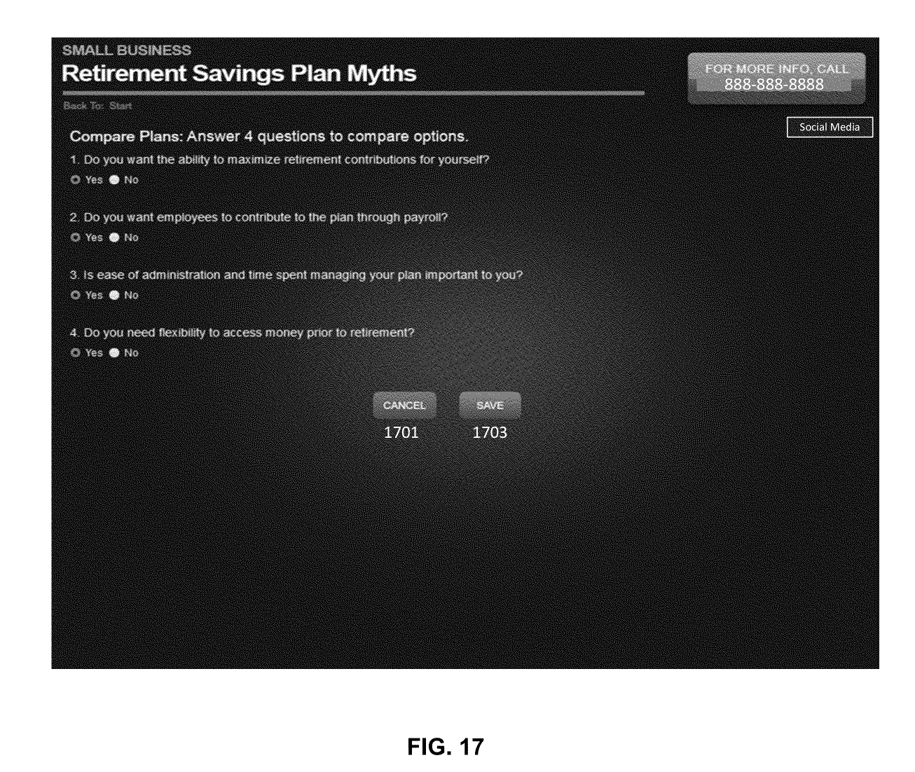

The retirement savings plan microsite may also comprise at least one of comparison link 909 or questionnaire link 505. Selection of either comparison link 909 or questionnaire link 505 is selected may serve as a request for a retirement savings plan suggestion. Enhanced computing server 101 may receive the request for a retirement savings plan suggestion at step 305. In response to the request, enhanced computing server 101 may display a plurality of retirement savings plan questions at step 307. An exemplary display of retirement savings plan questions is shown in FIG. 17.

In some instances, a user may select process initiation link 503 rather than a myth theme 403, 405, and 407. In response to selection of process initiation link 503, enhanced computing server may display a screen as shown in FIG. 10. As shown in FIG. 10, the screen may include a prompt to determine how many employees the user has. The options for response may be simplified into three categories—sole proprietorship, several employees, and many employees. Each employee option may comprise a graphical display of the option (such as the highlighted individual logos in FIG. 10) and an employee link 1001, 1003, and 1005. Each link may comprise a definition of the number of employees that qualify for each distinct option. For instance, a user may select employee link 1001 if the user has a sole proprietorship, defined as 0 to 1 employee. A user may select employee link 1005 if the user has several employees, defined as 2-10 employees. Finally, the user may select employee link 1005 if the user has many employees, defined as 11-100 employees.

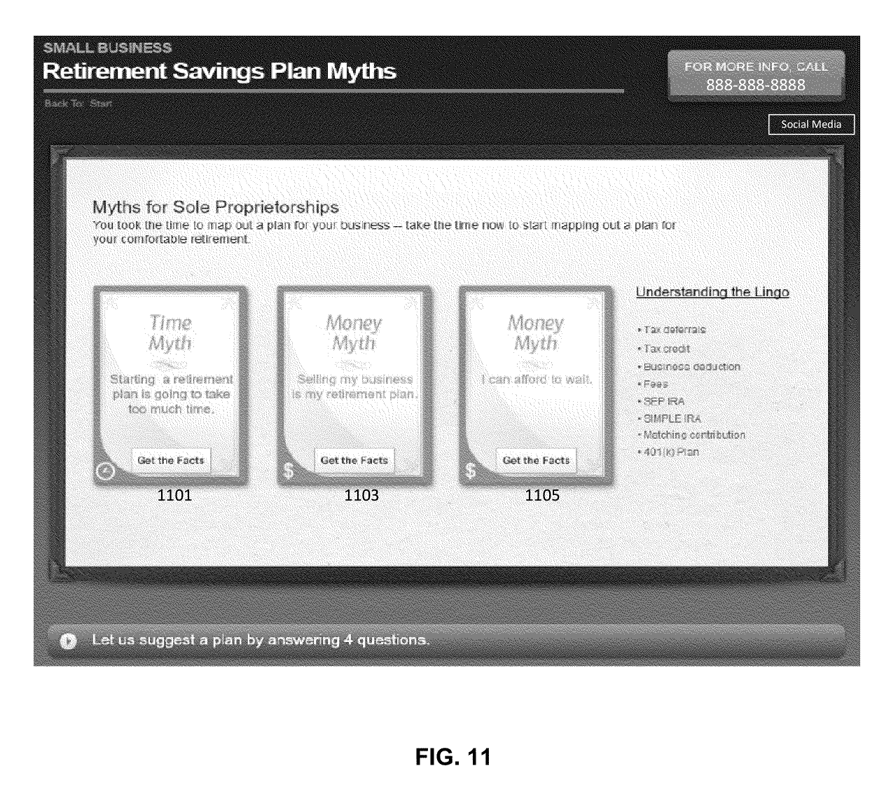

After a user has selected an employee link, enhanced computing server may display a screen as shown in FIG. 11. The screen shown in FIG. 11 is similar to the screen shown in FIG. 6. However, the myth cards shown in FIG. 11 may be configured by processor 103 according to the user's selected employee link. The exemplary screen provided in FIG. 11 may be displayed in response to selection of the sole proprietorship employee link 1001. As shown in FIG. 11, enhanced computing server 101 may display a time myth card 1101 and money myth cards 1103 and 1105. Enhanced computing server 101 may determine the most relevant myth cards for display at processor 103 according to permutations stored at memory 115. Thus, only the most pertinent myth cards may be displayed for the corresponding selected employee link. For instance, enhanced computing server 101 may determine that employee myths are not the most applicable for a sole proprietorship (with only 0 or 1 employee). Instead, enhanced computing server 101 may determine that money myths are among the most common concerns for a sole proprietor.

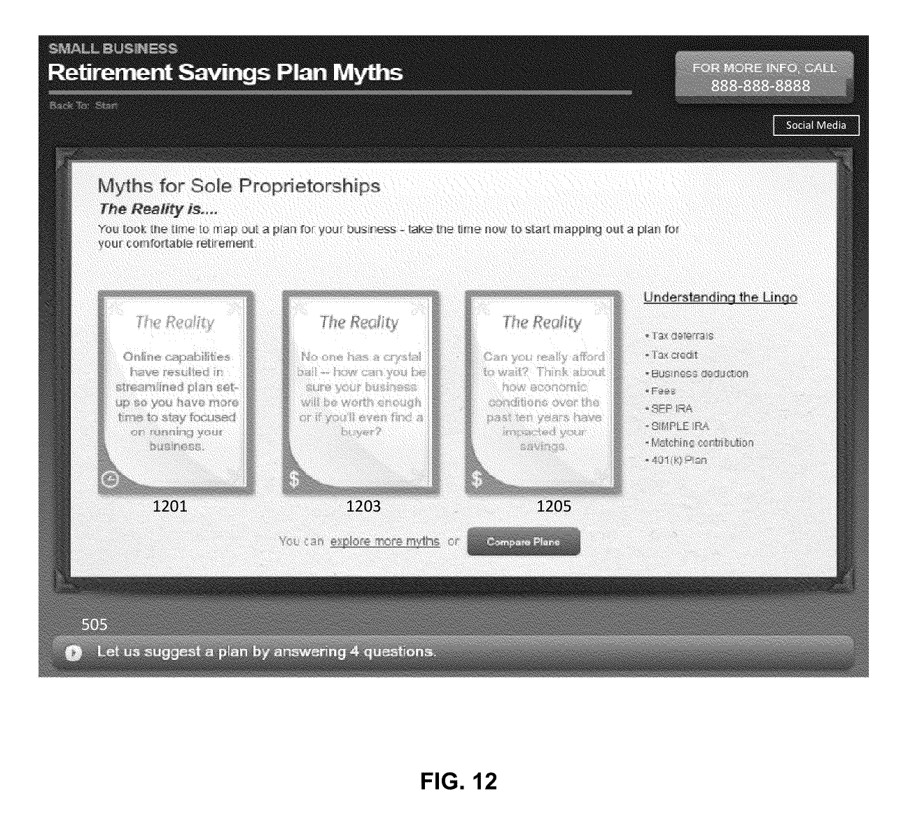

Selection of any of the Get the Facts links in myth cards 1101, 1103, and 1105 may cause processor 103 to display similar screens as discussed for FIGS. 7 and 8, above. A facts list may be provided to dispel the common myths provided in each selected myth card. Moreover, enhanced computing server 101 may display a screen as shown in FIG. 12. FIG. 12 may comprise reality cards 1201, 1203, and 1205 that correspond to myth cards 1101, 1103, and 1105, respectively. As discussed above with regards to FIG. 9, each of the reality cards may provide realities that bust each corresponding myth.

Enhanced computing server 101 may also display a questionnaire link 505. Selection of link 505 may cause enhanced computing server 101 to display a screen as shown in FIG. 13. Thus, enhanced computing server 101 may receive a request for a retirement savings plan suggestion at step 305 and display a plurality of retirement savings plan questions at step 307. As shown in Figure, a single question of four total questions may be displayed at question section 1309. A user's response to the question may cause processor 103 to analyze the answer to the question and generate a suggested retirement savings plan at step 311. As each question is answered “yes” or “no” at question section 309, enhanced computing server 101 may display how the answer affects three retirement savings plan options—Simplified Employee Pension Individual Retirement Arrangement (SEP IRA), a 401(k) plan, and a SIMPLE (Savings Incentive Match Plan for Employees) IRA. SEP IRA box 1301 may display whether enhanced computing server 101 suggests SEP IRA based on the user's answer to the provided question. A similar indication may be provided for 401(k) Plan box 1303 and SIMPLE IRA box 1305.

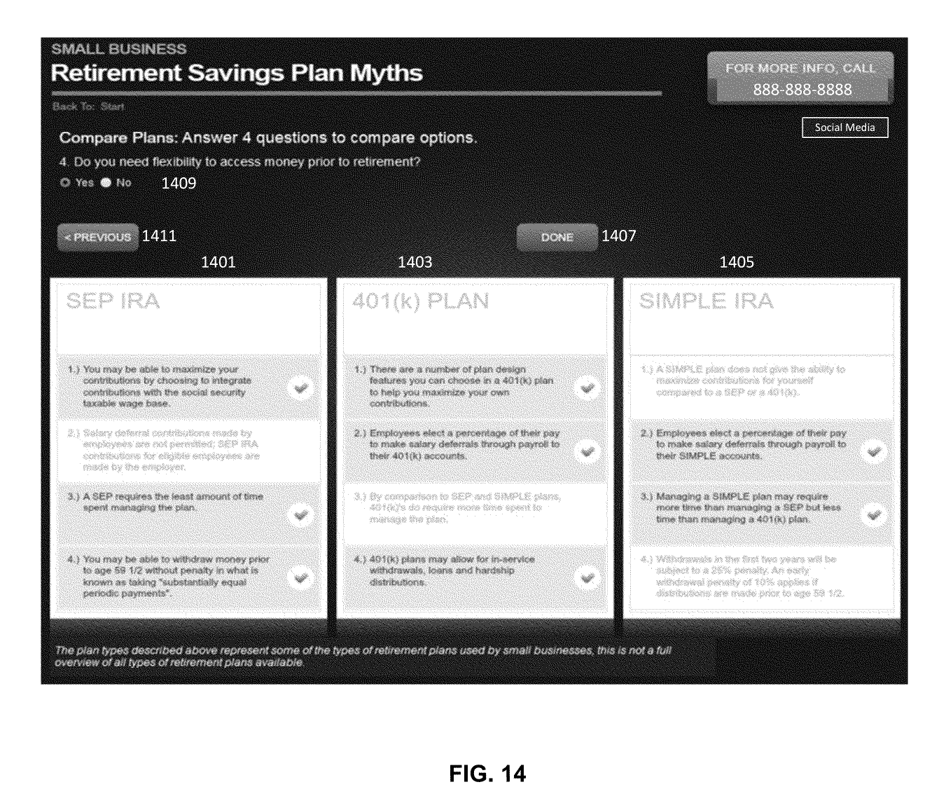

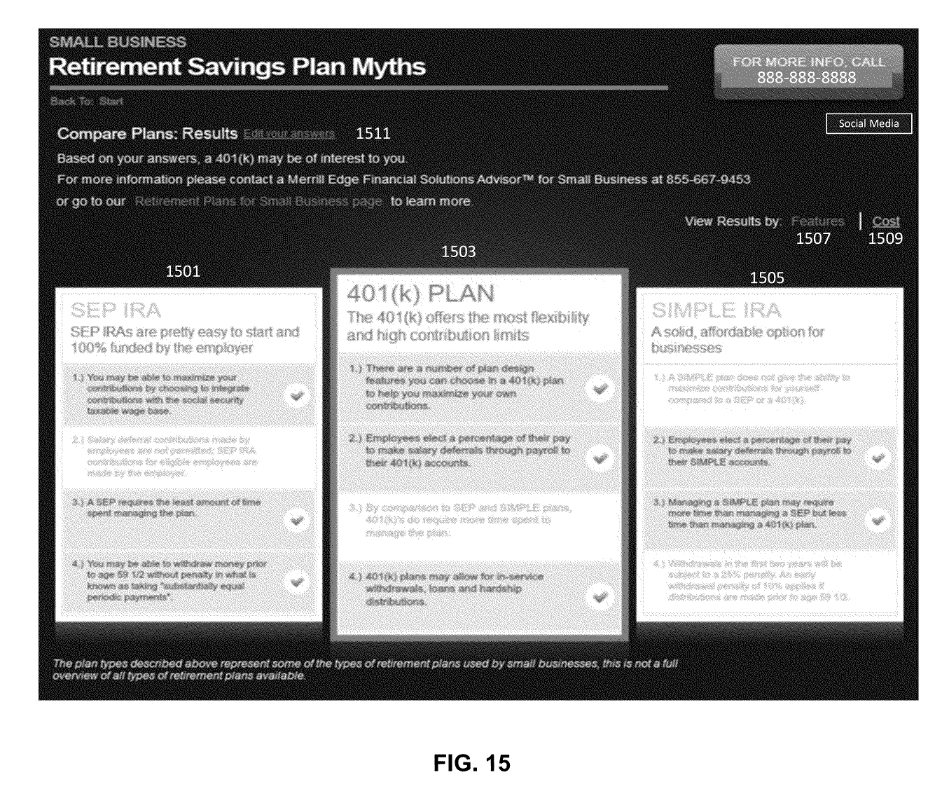

After inputting an answer to the provided question, a user may select next link 1307 to advance to the next of the four questions. Each successive answer to a provided question may cause enhanced computing server 101 to provide further indications with regards to the benefits of each retirement savings plan types. When the user reaches the final question, as shown in FIG. 14, enhanced computing server may display an updated SEP IRA box 1401, 401(k) Plan box 1403, and SIMPLE IRA box 1405. For each answer to each of the four questions, each box 1401, 1403, and 1405 may include an indication (such as highlighting and/or check mark) along with additional information as to how the particular plan type may address the issue provided in the corresponding question. For example, question four may ask “Do you need the flexibility to access money prior to retirement?” A user may respond “yes” to question four and, as shown in FIG. 14, SEP IRA box 1401 and 401(k) Plan box 1403 may be highlight with a checkmark for the fourth listed issue in each box. SIMPLE IRA box 1405, which may not provide the flexibility desired by the user in question four, may not be highlighted for the fourth issue. In certain aspects, the retirement savings plan microsite may display four questions. The questions may comprise the following: 1) “Do you want the ability to maximize retirement plan contributions to yourself?” 2) “Do you want your employees to contribute to the plan through payroll?” 3) “Is ease of administration and time spent managing your plan important to you?” 4) “Do you need the flexibility to access money prior to retirement?” A user may return to previous questions by selecting previous link 1411 and may select done link 1407 to proceed to the screen shown in FIG. 15.

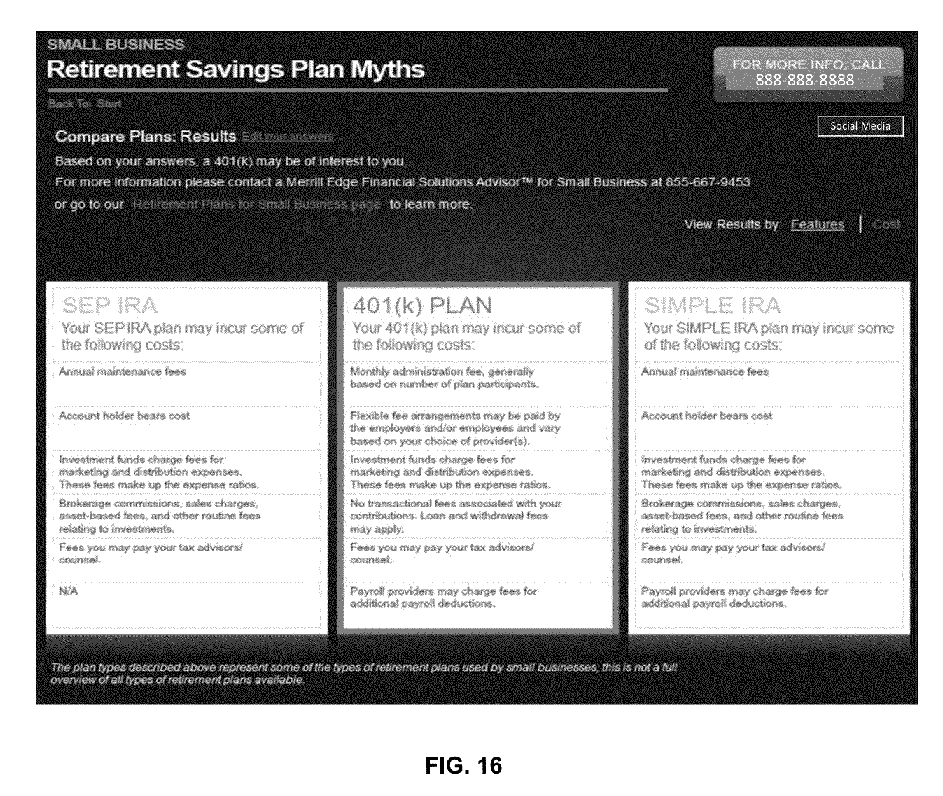

After analyzing the answers to the plurality of retirement savings plan questions to generate a suggested retirement savings plan at step 311, enhanced computing server 101 may output the suggested retirement savings plan type at step 313. An exemplary output is shown in FIG. 15. The retirement savings plan microsite may display retirement savings plan options 1501, 1503, and 1505. Each of the options 1501, 1503, and 1505 may comprise a brief description of the plan. For example, option 1501 may comprise of a brief description of SEP IRAs (“SEP IRAs are pretty easy to start and 100% funded by the employer”). Each option 1501, 1503, and 1505 may also comprise a statement of how each plan type may or may not meet the criteria; a features/plan comparison chart of how each plan type stacks up against the criteria, and a callout when the retirement savings plan option meets the criteria elaborated in the question. For example, the question may be highlighted and a check mark may be placed next to the question when the savings plan meets the criteria elaborated in the question. Moreover, the suggested retirement savings plan type may be highlighted and brought forth at the screen shown in FIG. 15. In the example provided in FIG. 15, a 401(k) is the suggested retirement savings plan type and is visually highlighted and separated from the SEP IRA and SIMPLE IRA options. Enhanced computing server 101 may enable a user to toggle back and forth between features comparison charts shown in FIG. 15 and cost comparison charts shown in FIG. 16.

The retirement savings plan microsite may also comprise an edit link 1511. When edit link 1511 is selected, the enhanced computing server 101 may return the user to a screen similar to the screen shown in FIG. 17 8 so that the user may edit one or more answers. The retirement savings plan microsite may also comprise a features link 1507 and costs link 1509. When the features link 1507 is selected, the enhanced computing server may display a screen similar to the screen shown in FIG. 15. When the costs link 1509 is selected, enhanced computing server 101 may display a screen similar to the screen shown in FIG. 16. As shown in FIG. 16, the retirement savings plan microsite may display the types of costs associated with each of the three retirement savings plan type options; a cost comparison chart. Likewise, the suggested retirement savings plan option may be highlighted (401(k) plan in exemplary FIG. 16).

As shown in FIG. 17, the retirement savings plan microsite may display answer options corresponding to each of the four questions. A user may select an answer option (such as “yes” or “no”) for each question. In certain aspects, the screen shown in FIG. 17 may only be displayed when a user has requested to edit previously entered answers. After making any changes to the previously provided answers, enhanced computing server 101 may display save link 1703 which may enable the user to save any new answers. The user may also select cancel link 1701 to return to a previous screen of the microsite and, in some aspects, may select a done link (not shown) to proceed to another screen, such as the screen shown in FIG. 15.

Enhanced computing server 101 may then analyze the answers to the plurality of retirement savings plan questions to generate a suggested retirement savings plan at step 311. In some aspects, all data received is maintained at the session level, without saving or storing received data at memory 115. Instead, answers may be stored for the length of the session and the user may choose to refresh or close out and re-enter the microsite to clear session answers. In certain aspects, suggested retirement savings plan comprises of at least one of a Simplified Employee Pension Individual Retirement Arrangement (SEP IRA), a 401(k) plan, and a SIMPLE (Savings Incentive Match Plan for Employees) IRA. These three retirement savings plan types options may be the most commonly chosen and viable plan types for sole proprietors and small business owners. Thus, these three options may be stored at memory 115, and the answers provided at step 309 may be analyzed which of the three options most closely match the user's small business retirement savings plan needs.

Memory 115 may also store a set of permutation rules. The set of permutation rules may be applied to the answers received at step 309 to generate the suggested retirement savings plan type. In some aspects, the set of permutation rules may assign weights to the answers to the retirement savings plan questions in order to generate a suggested retirement savings plan type. As disclosed earlier and shown in FIG. 17, the retirement savings plan microsite may display four questions. User answers to the four questions may comprise one of 16 permutations. The set of permutation rules may comprise a set of rules for each of the 16 permutations. For example, if a user answers “yes” to questions 1, 3, and 4, and “no” to question 2, the set of permutation rules may generate a suggested retirement savings plan of SEP IRA. In another example, if a user answers “yes” to questions 1 and 2, and “no” to questions 3 and 4, the set of permutation rules may generate a suggested retirement savings plan of 401(k).

In some aspects, one or more questions may be weighted more heavily than others. For example, answers to questions 1, 2, and 3 may all trend towards suggesting a SIMPLE IRA. However, the answer to question 4 may trend away from suggesting a SIMPLE IRA. The answer to question 4 may be weighted more heavily than the answers to questions 1, 2, and 3, such that the retirement savings plan microsite does not suggest a SIMPLE IRA. In other words, the answers may be weighted such that two plans may similarly meet a user's criteria (such as “access to money prior to retirement”), but one may stand out based on the user's sentiment (such as “ease”) or desired method of contributing, (“payroll”, and the like).

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. For example, the described implementation includes software by the present disclosure may be implemented as a combination of hardware and software or in hardware alone. Additionally, although aspects of the present disclosure are described as being stored in memory, one skilled in the art will appreciate that these aspects can also be stored on other types of computer-readable media, such as secondary storage devices, like hard disks, floppy disks, or CD-ROM.

What is claimed is:

1. A computer-implemented method, comprising:
receiving, at an enhanced computing server, a request to view retirement savings plan information;
displaying, at the enhanced computing server, the retirement savings plan information, wherein the retirement savings plan information provides myth-busting facts to common retirement savings plan myths;
receiving, at the enhanced computing server, a request for a retirement savings plan type suggestion;
displaying, at the enhanced computing server, a plurality of retirement savings plan questions;
receiving, at the enhanced computing server, answers to the plurality of retirement savings plan questions;
analyzing, at the enhanced computing server, the answers to the plurality of retirement savings plan questions to generate a suggested retirement savings plan type, wherein the suggested retirement savings plan type is generated by applying a set of permutation rules to the answers to the plurality of retirement savings plan questions; and
outputting, at the enhanced computing server, the suggested retirement savings plan type.

2. The method of claim 1, wherein the retirement savings plan information comprises information specifically tailored for small businesses.

3. The method of claim 1, wherein the common retirement savings plan myths consists of three myth themes.

4. The method of claim 3, wherein the three common retirement savings plan myths consists of time myths, money myths, and employee myths.

5. The method of claim 1, wherein the plurality of retirement savings plan questions consists of four questions.

6. The method of claim 1, wherein the set of permutation rules assigns weights to the answers to the retirement savings plan questions in order to generate a suggested retirement savings plan type.

7. The method of claim 1, wherein the suggested retirement savings plan comprises of at least one of a Simplified Employee Pension Individual Retirement Arrangement (SEP IRA), a 401(k) plan, and a Savings Incentive Match Plan for Employees (SIMPLE) IRA.

8. A non-transitory computer-readable storage medium having computer-executable program instructions stored thereon that, when executed by a processor, cause the processor to:
receive a request to view retirement savings plan information;
output the retirement savings plan information, wherein the retirement savings plan information provides myth-busting facts to common retirement savings plan myths;
receive a request for a retirement savings plan type suggestion;
output a plurality of retirement savings plan questions;
receive answers to the plurality of retirement savings plan questions;
analyze the answers to the plurality of retirement savings plan questions to generate a suggested retirement savings plan, wherein the suggested retirement savings plan type is generated by applying a set of permutation rules to the answers to the plurality of retirement savings plan questions; and
output the suggested retirement savings plan type.

9. The non-transitory computer-readable storage medium of claim 8, wherein the retirement savings plan information comprises information specifically tailored for small businesses.

10. The transitory computer-readable storage medium of claim 8, wherein the common retirement savings plan myths consists of three myth themes.

11. The transitory computer-readable storage medium of claim 10, wherein the three common retirement savings plan myths consists of time myths, money myths, and employee myths.

12. The transitory computer-readable storage medium of claim 8, wherein the plurality of retirement savings plan questions consists of four questions.

13. The transitory computer-readable storage medium of claim 8, wherein the set of permutation rules assigns weights to the answers to the retirement savings plan questions in order to generate a suggested retirement savings plan type.

14. An apparatus comprising:
a memory;
a processor, wherein the processor executes computer-executable program instructions which cause the processor to:
receive a request to view retirement savings plan information;
output the retirement savings plan information, wherein the retirement savings plan information provides myth-busting facts to common retirement savings plan myths;
receive a request for a retirement savings plan type suggestion;
output a plurality of retirement savings plan questions;
receive answers to the plurality of retirement savings plan questions;
analyze the answers to the plurality of retirement savings plan questions to generate a suggested retirement savings plan type, wherein the suggested retirement savings plan type is generated by applying a set of permutation rules to the answers to the plurality of retirement savings plan questions; and
output the suggested retirement savings plan type.

15. The apparatus of claim 14, wherein the retirement savings plan information comprises information specifically tailored for small businesses.

16. The apparatus of claim 14, wherein the common retirement savings plan myths consists of three myth themes.

17. The apparatus of claim 16, wherein the three common retirement savings plan myths consists of time myths, money myths, and employee myths.

18. The apparatus of claim 14, wherein the plurality of retirement savings plan questions consists of four questions.

19. The apparatus of claim 14, wherein the set of permutation rules assigns weights to the answers to the retirement savings plan questions in order to generate a suggested retirement savings plan type.

20. The apparatus of claim 14, wherein the suggested retirement savings plan comprises of at least one of a Simplified Employee Pension Individual Retirement Arrangement (SEP IRA), a 401(k) plan, and a Savings Incentive Match Plan for Employees (SIMPLE) IRA.
